(19) United States
(12) Patent Application Publication
(10) Pub. No.: US 2011/0174096 A1
(43) Pub. Date: Jul. 21, 2011

(54) SYNCHRONOUS PEDAL CRANK DRIVE FOR BICYCLES OR SIMILAR

(76) Inventor: Franz Florschütz, Kiel (DE)

(21) Appl. No.: 10/567,525

(22) PCT Filed: Aug. 4, 2004
(86) PCT No.: PCT/DE2004/001740

§ 371 Date: May 17, 2007

(30) Foreign Application Priority Data
Aug. 12, 2003 (DE) 103 36 981.3

(51) Int. Cl. B62M 3/02; B62M 1/02

(52) U.S. Cl. 74/68

(57) ABSTRACT

The conventional pedal crank drive from DE 43 11 404 C2 has second crank arms (2), connected to the outside of the first crank arms (1), by means of a rotating joint (3) and each comprises a pedal (5), with adjustable angular inclination. Said drive system has the problem that the extended pedal crank unit does not have the required stiffness before the bottom deadpoint to convert the full pedal traction force into torque.

According to the invention, said problem is overcome whereby a carrier plate (4) is arranged on the first crank arm in the vicinity of the rotating joint (3) with an angular adjustment and a ratchet mechanism (7) is arranged on the second crank arm, such that the rotating joint is periodically locked in the region of the bottom deadpoint and hence a double length rigid force arm is formed, whereby the pedal traction force is ergonomically converted into maximum torque with the large radius from A to B.

The synchronous pedal crank drive is universally suited for bicycles, bicycle ergometers, fitness and health training, during times of rehabilitation as well as in sports medicine and occupational medicine, as well as for specialised pedal-driven equipment for example, pedal-driven aircraft, stationary bikes, pedal boats, for astronauts in space, and so on.

The invention is an enhancement to the synchronous pedal crank drive named in the preamble for bicycles from DE 43 11 404 C2.

Said drive system has the problem that the extended pedal crank unit forms a straight angle (when the leg is extended) during the pedal orbit before the bottom deadpoint and as such reaches double crank length but does not have the stiffness to convert the full pedal traction into torque.

Each of the said pamphlets FR 516201 and FR 759464 only deals with a pedal crank unit whereby a relatively short foot pedal arm is hung on the foot pedal axel of the pedal crank via a free wheel device and can only orbit in one rotational direction. A permanent lock such as this type also has serious disadvantages, particularly if the rotational direction of the pedal activity changes as during back pedalling as well as when stopping or when beginning the pedalling movement. As a consequence, the fixed angle of the pedal crank unit prevents the levelling off of the pedal arm in an ergonomic position for the foot. In addition the surmounting of the upper deadpoint by such a short foot pedal arm can however not achieve an ergonomic pedalling action. In patent specification CH 171928 a cycle driving gear is described for which the pedal crank is constructed in the form of a bent leaf spring. In this case the leaf spring stretches through the pedalling motion, whereby the active torsion arm extends. Additional constructions are described here whereby it is also a matter of lengthening the active crank arm when in a horizontal position.

The task of the invention therefore is periodically to block the rotating joint of the extended pedal crank unit in the phases of the pedal orbit before the bottom deadpoint so that the crank arms are rigidly connected with each other whereby the pedal traction force enables a maximum torque with no loss incurred.

According to the invention, this task is solved by the characteristics of the preamble. The secondary claims render advantageous forms of construction.

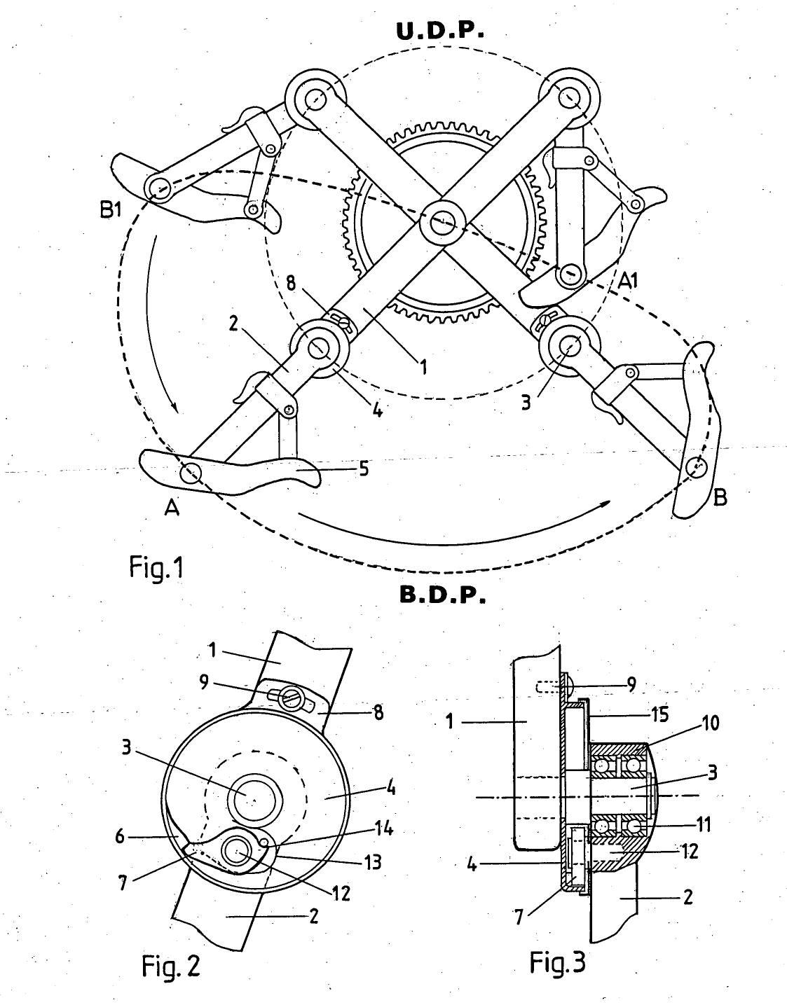

The advantages that can be achieved with the invention lie in the fact that the periodic stiffening of the extended pedal crank unit forms a double-length rigid force arm by which a double length strong pedal traction force with tangential components creates maximum torque from A to B (FIG. 1) beyond the bottom deadpoint. At the same time, the pedal thrust from A1 to B2 achieves torque beyond the upper deadpoint. In addition, the new type of pedal crank drive is ergonomically so well adjusted to the physique that in a low sitting position a natural motion sequence allows legwork in an oval-shaped pedal orbit with consistent use of force (corresponding to the guage) This type of dynamic work provides for rhythmic participation of the muscles involved and as such achieves the highest efficiency in a manner that is comfortable, free of fatigue, and that prevents damage to joints.

The synchronous pedal crank drive can be used for bicycles with an appropriate frame-construction. In addition, this pedal drive, with all of its advantages, can be used across-the-board for bicycle ergometers, fitness and health training, for rehabilitation purposes up to performance training as well as in sport and occupational medicine. This pedal drive is also well suited for special devices with pedal drives, such as pedal-driven aircraft, stationary bikes, pedal boats, for astronauts in space and so on.

The following contains a more detailed description of the invention's mode of operation. FIG. 1 illustrates the form of the ergonomically oval pedal orbit which is achieved in low sitting position especially suited for this drive system. After the pedal thrust from position B1, the pedal pressure is downward whereby the pedal crank unit is extended by the extension of the leg forward to position A of the pedal orbit. During the extension of the pedal crank unit the second pedal crank arm 2 in rotating joint 3 orbits in the opposite direction to the first pedal arm 1. In doing so, the ratchet mechanism 7 slides across the ratchet of the carrier plate 4 and the rotational direction of the second pedal arm changes downward because of the pedal traction force to be used on it so that the ratchet mechanism locks into the ratchet whereby a double length rigid force arm is formed. After the pedal traction force from position B, the rotational direction of the second crank arm changes again in the rotating joint whereby the lock is removed. With the angular adjustment plate 8 the extended angle of the pedal crank unit can be adjusted by increasing or decreasing in this manner by turning the carrier plate in the appropriate direction and by fixing the concentric groove with the locking screw. From the mode of operation depicted, it becomes clear that a stiff, extended, double-length force arm is formed by the periodic locking device. The force arm doubles the pedal traction force with a tangential component in an ergonomic manner in a large arc radius and creates maximum torque from position A to B (one quarter of the crank circle).

The diagrams provide an example of how the invention operates. This operation is described below in greater detail.

The following are illustrated:

FIG. 1 illustrates the complete pedal crank drive as well as the mode of operation,

FIG. 2 illustrates the front view of the periodic locking device,

FIG. 3 illustrates a cross section of the periodic locking device.

FIG. 1 illustrates the synchronous pedal crank drive for bicycles or the like, which are essentially the first crank arms 1 that as usual are attached by the upper head to the crank axel 3 and on whose lower eyes the second crank arms 2 are securely screwed with rotating joint axel and carrier plate 4 and on whose lower eye outside a pedal 5 is attached with an adjustable angular inclination. On the ergonomically oval pedal orbit, the rigid stretched pedal crank unit is illustrated in position A and B during the pedal traction force backwards across the bottom deadpoint and in position A1 and B1 the pedal thrust that occurs simultaneously in a forward motion across the upper deadpoint is depicted. The dotted line shows the normal crank circle compared to the ergonomically oval pedal orbit. FIGS. 2 and 3 illustrate the assembly of the periodic locking device whereby the carrier plate 4 with the central borehole is attached to the screw thread of the rotating joint axel 3 and is securely screwed to the lower eye of the first crank arm 1. Ratchet 6 is assembled on the inner radius of the cylindrical part of carrier plate 4 in such a manner that this is carried along by the locking of ratchet mechanism 7 in each pedal traction direction. The angular adjustment plate 8 with the concentric groove, which is fastened to the first crank arms by means of a locking screw 9, is attached to the incumbent side of the carrier plate. The rotating joint axel 3 is held on the upper head 10 of the second crank arm of the deep groove ball bearing 11 while underneath the bearing and the head a pin 12 is attached on the inside upon which ratchet mechanism 7 pivots and is secured by a circlip. At the feather-edged end of the ratchet mechanism, a small borehole is braced to the rotating joint axel 3 as a bearing for pressure spring 13 which is tautened in an arch. On the rounded end of the ratchet mechanism there is a stop screw 14 which restricts the spring pressure via a pin attached to the protective cover 15.

The ratchet of the carrier plate 4 on the first crank arms and ratchet mechanism 7 on the second crank arms are assembled in such a manner that these lock in each case when the pedal crank unit is extended in the pedal traction direction and as such block the rotating joint. A removable protective cap 15 is on the head of the second crank arms which is secured with pin 12. The pedal crank unit of the invention was engineered with the usual normal crank arms. The crank arms can also be adjusted and manufactured specifically for this drive system. In doing so, head 10 with the bearing can be attached to the lower end of the first crank arms and accordingly a second crank arm with the upper eye for the connection to the rotating joint axel and the lower eye for the pedal connection. The periodic locking device is in turn also attached in this case.

1. Synchronous pedal crank drive for bicycles or the like for which the pedal bearing is arranged above the plane which is formed by the axel, with a pair of first crank arms (1), which are fastened to a pedal crank axel arranged in the pedal bearing whereby two crank arms (2) are attached to the outsides of the first crank arms respectively outside above a rotation joint (3). The crank arms at the end set off by the rotating joint each have a pedal (5) and the first and second crank arms are essentially of the same length and between each pedal and the assigned second crank arm is a pull rod which on the one hand at the lower end of the pedal attaches above the pedal to locking barrels which can be adjusted with a hand lever on the other hand above the pedal and this is smoothly adjustable on the second crank arm to provide the pedal a fixed angle in relationship to the second crank arm and that the pedal is essentially formed with a flat surface for the balls of the feet where a convex rise at the rear of the pedal attaches in the midsection to support the midfoot,
distinguished by the fact that
between the first and second crank arms (1, 2) on the one side on the screw thread of the rotating joint axel (3) a carrier plate (4) is attached and tightly screwed on the inside with the assigned crank arm (1) and on the other hand on the second crank arm (2) underneath its bearing head (10) a pin is attached (12) where a ratchet mechanism (7) pivots and this locks when the extended pedal crank unit is extended by spring pressure (13) at the closing of a ratchet (6) of the carrier plate (4) to achieve a stiff angle of the assigned first and second crank arms (1, 2) in the area of the lower deadpoint and that a protective cover (15) is arranged on the bearing head (10) inside.

2. Synchronous pedal crank drive for bicycles or similar according to claim 1
distinguished by the fact that
the carrier plate (4) has a central borehole for the screw thread and a cylindrical form on the outer edge, onto whose inner radius the ratchet (6) is assembled in such a way that the pedal crank unit is locked in each pedal traction direction and as a result forms a double length rigid force arm.

3. Synchronous pedal crank drive for bicycles or similar according to claims 1 and 2
distinguished by the fact that
at the far end of the ratchet (6) on the outside edge of the carrier plate (4) an angular adjustment plate (8) with concentric groove is attached and this is fastened to the crank arm (1) by means of a locking screw (9).

4. Synchronous pedal crank drive for bicycles or similar according to claim 1
distinguished by the fact that
the ratchet mechanism (7) has a small borehole for the bearing of the pressure spring (13) which is tautened in an arch braced to the rotating joint axel while on the rounded end of the ratchet mechanism a screw is provided (14) where the feed stop of the spring pressure is restricted by a pin.
